(19) United States
(12) Patent Application Publication
(10) Pub. No.: US 2002/0056349 A1
(43) Pub. Date: May 16, 2002

(54) Miter saw with improved safety system

(76) Inventors: Stephen F. Gass, Wilsonville, OR (US); J. David Fulmer, Tualatin, OR (US)

Correspondence Address: SD3, LLC, 22409 S.W. NEWLAND ROAD, WILSONVILLE, OR, 97070, US

(21) Appl. No.: 10/050,085

(22) Filed: Jan. 14, 2002

Related U.S. Application Data
(63) Continuation-in-part of application No. 09/676,190, filed on Sep. 29, 2000.
(63) Continuation-in-part of application No. 09/929,221, filed on Aug. 13, 2001.
(63) Continuation-in-part of application No. 09/929,226, filed on Aug. 13, 2001.
(63) Continuation-in-part of application No. 09/929,227, filed on Aug. 13, 2001.
(63) Continuation-in-part of application No. 09/929,234, filed on Aug. 13, 2001.
(63) Continuation-in-part of application No. 09/929,235, filed on Aug. 13, 2001.
(63) Continuation-in-part of application No. 09/929,236, filed on Aug. 13, 2001.
(63) Continuation-in-part of application No. 09/929,237, filed on Aug. 13, 2001.
(63) Continuation-in-part of application No. 09/929,238, filed on Aug. 13, 2001.
(63) Continuation-in-part of application No. 09/929,240, filed on Aug. 13, 2001.
(63) Continuation-in-part of application No. 09/929,241, filed on Aug. 13, 2001.
(63) Continuation-in-part of application No. 09/929,242, filed on Aug. 13, 2001.
(63) Continuation-in-part of application No. 09/929,244, filed on Aug. 13, 2001.
(63) Continuation-in-part of application No. 09/929,425, filed on Aug. 13, 2001.
(63) Continuation-in-part of application No. 09/929,426, filed on Aug. 13, 2001.
(60) Provisional application No. 60/270,011, filed on Feb. 20, 2001.
(60) Provisional application No. 60/270,941, filed on Feb. 22, 2001.
(60) Provisional application No. 60/270,942, filed on Feb. 22, 2001.
(60) Provisional application No. 60/273,177, filed on Mar. 2, 2001.
(60) Provisional application No. 60/273,178, filed on Mar. 2, 2001.

(51) Int. Cl. B26D 1/14; B27B 5/00

(52) U.S. Cl. 83/62.1; 83/DIG. 1; 83/397; 83/477.1; 83/471.3; 83/630

(57) ABSTRACT

A miter saw is disclosed having a base, a blade supported by the base, a detection system adapted to detect a dangerous condition between a person and the blade, and a reaction system associated with the detection system to cause a predetermined action to take place upon detection of the dangerous condition. The blade is rotatable, and moves into a cutting zone to cut a workpiece. The predetermined action may be to stop the blade from rotating, to create an impulse against movement of the blade into the cutting zone, or to cause the blade to move away from the cutting zone.

### CROSS-REFERENCE TO RELATED APPLICATIONS

This application is a continuation-in-part of the following U.S. patent applications: Ser. No. 09/676,190, filed Sep. 29, 2000, Ser. No. 09/929,221, filed Aug. 13, 2001, Ser. No. 09/929,226, filed Aug. 13, 2001, Ser. No. 09/929,227, filed Aug. 13, 2001, Ser. No. 09/929,234, filed Aug. 13, 2001, Ser. No. 09/929,235, filed Aug. 13, 2001, Ser. No. 09/929,236, filed Aug. 13, 2001, Ser. No. 09/929,237, filed Aug. 13, 2001, Ser. No. 09/929,238, filed Aug. 13, 2001, Ser. No. 09/929,240, filed Aug. 13, 2001, Ser. No. 09/929,241, filed Aug. 13, 2001, Ser. No. 09/929,242, filed Aug. 13, 2001, Ser. No. 09/929,244, filed Aug. 13, 2001, Ser. No. 09/929,425, filed Aug. 13, 2001, and Ser. No. 09/929,426, filed Aug. 13, 2001.

This application claims the benefit of and priority from the following U.S. Provisional Patent Applications: Serial No. 60/270,011, filed Feb. 20, 2001, Serial No. 60/270,941, filed Feb. 22, 2001, Serial No. 60/270,942, filed Feb. 22, 2001, Serial No. 60/273,177, filed Mar. 2, 2001, and Serial No. 60/273,178, filed Mar. 2, 2001.

### FIELD OF THE INVENTION

The present invention relates to miter saws, and more particularly to a miter saw with a high-speed safety system.

### BACKGROUND AND SUMMARY OF THE INVENTION

Miter saws are a type of woodworking machinery used to cut workpieces of wood, plastic and other materials. Miter saws typically include a base upon which workpieces are placed and include a circular saw blade mounted on a pivot arm. A person uses a miter saw by placing a workpiece on the base beneath the upraised blade and then bringing the blade down via the pivot arm to cut the workpiece. Miter saws present a risk of injury to users because the spinning blade is often exposed when in use. Furthermore, users often use their hands to position and support workpieces beneath the blade, which increases the chance that an injury will occur.

The present invention provides a miter saw with an improved safety system that is adapted to detect the occurrence of one or more dangerous, or triggering, conditions during use of the miter saw, such as when a user's body contacts the spinning saw blade. When such a condition occurs, the safety system is actuated to limit or even prevent injury to the user.

### BRIEF DESCRIPTION OF THE DRAWINGS

FIG. 1 is a schematic block diagram of a miter saw with a fast-acting safety system according to the present invention.

FIG. 2 is a schematic diagram of an exemplary safety system configured to stop the miter saw blade.

FIG. 3 is a schematic side elevation of an exemplary miter saw having a safety system configured to stop both the rotation and downward movement of the blade.

FIG. 4 is similar to FIG. 3 but shows the pivot arm assembly pivoted upward.

FIG. 5 is a schematic cross-sectional view taken generally along the line 5-5 in FIG. 4.

FIG. 6 is similar to FIG. 3 but shows the brake pawl engaging the blade.

### DETAILED DESCRIPTION AND BEST MODE OF THE INVENTION

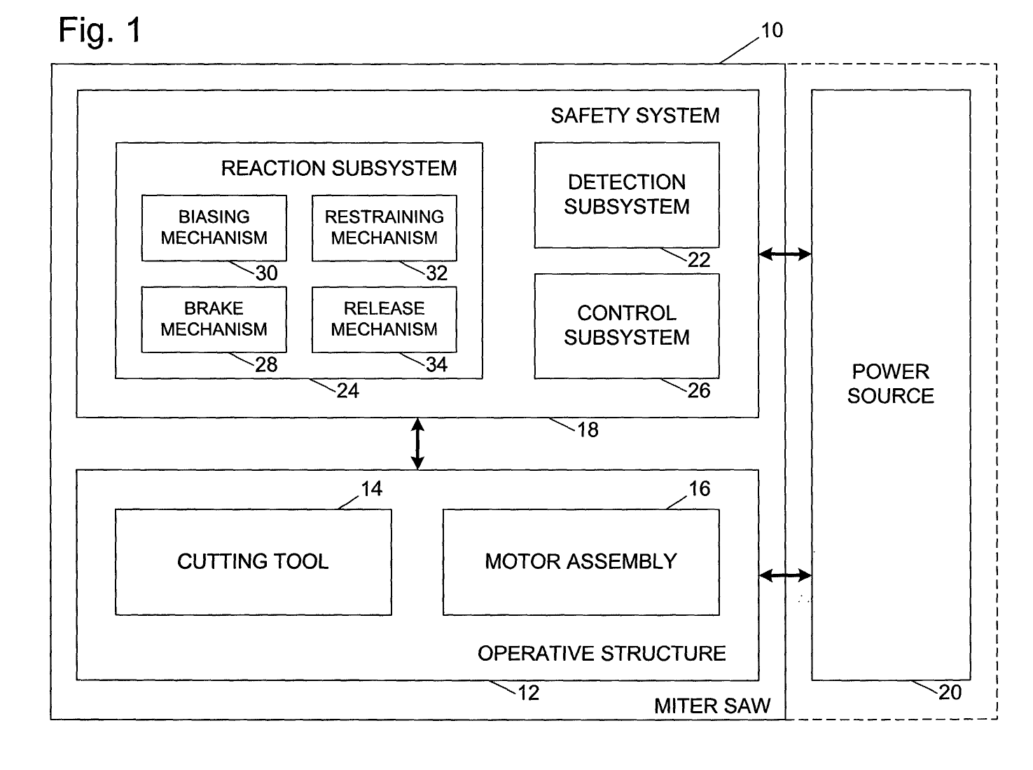

A miter saw according to the present invention is shown schematically in FIG. 1 and indicated generally at 10. Miter saw 10 may be any of a variety of different types and configurations of miter saw adapted for cutting workpieces, such as wood, plastic, etc. Miter saw 10 includes an operative structure 12 having a cutting tool 14 and a motor assembly 16 adapted to drive the cutting tool. Miter saw 10 also includes a safety system 18 configured to minimize the potential of a serious injury to a person using miter saw 10. Safety system 18 is adapted to detect the occurrence of one or more dangerous, or triggering, conditions during use of miter saw 10. If such a dangerous condition is detected, safety system 18 is adapted to engage operative structure 12 to limit any injury to the user caused by the dangerous condition.

Miter saw 10 also includes a suitable power source 20 to provide power to operative structure 12 and safety system 18. Power source 20 may be an external power source such as line current, or an internal power source such as a battery. Alternatively, power source 20 may include a combination of both external and internal power sources. Furthermore, power source 20 may include two or more separate power sources, each adapted to power different portions of miter saw 10.

It will be appreciated that operative structure 12 may take any one of many different forms, depending on the type of miter saw 10. As will be described in more detail below, operative structure 12 typically takes the form of an arm pivotally coupled to a base. Cutting tool 14 is mounted on the arm and pivotal toward a workpiece supported by the base. Alternatively, the arm may be both pivotally and slidably coupled to the base.

Motor assembly 16 includes one or more motors adapted to drive cutting tool 14. The motors may be either directly or indirectly coupled to the cutting tool. Typically, motor assembly 16 is mounted on the pivot arm and directly coupled to the cutting tool.

Safety system 18 includes a detection subsystem 22, a reaction subsystem 24 and a control subsystem 26. Control subsystem 26 may be adapted to receive inputs from a variety of sources including detection subsystem 22, reaction subsystem 24, operative structure 12 and motor assembly 16. The control subsystem may also include one or more sensors adapted to monitor selected parameters of miter saw 10. In addition, control subsystem 26 typically includes one or more instruments operable by a user to control the miter saw. The control subsystem is configured to control miter saw 10 in response to the inputs it receives.

Detection subsystem 22 is configured to detect one or more dangerous, or triggering, conditions during use of miter saw 10. For example, the detection subsystem may be configured to detect that a portion of the user's body is dangerously close to, or in contact with, a portion of cutting tool 14. As another example, the detection subsystem may be configured to detect the rapid movement of a workpiece due to kickback by the cutting tool, as is described in U.S. Provisional Patent Application Serial No. 60/182,866, filed Feb. 16, 2000 and U.S. patent application Ser. No. 09/676,190, filed Sep. 29, 2000, the disclosures of which are herein incorporated by reference. In some embodiments, detection subsystem 22 may inform control subsystem 26 of the dangerous condition, which then activates reaction subsystem 24. In other embodiments, the detection subsystem may be adapted to activate the reaction subsystem directly.

Once activated in response to a dangerous condition, reaction subsystem 24 is configured to engage operative structure 12 quickly to prevent serious injury to the user. It will be appreciated that the particular action to be taken by reaction subsystem 24 will vary depending on the type of miter saw 10 and/or the dangerous condition that is detected. For example, reaction subsystem 24 may be configured to do one or more of the following: stop the movement of cutting tool 14, disconnect motor assembly 16 from power source 20, place a barrier between the cutting tool and the user, retract the cutting tool from its operating position, etc. The reaction subsystem may be configured to take a combination of steps to protect the user from serious injury. Placement of a barrier between the cutting tool and teeth is described in more detail in U.S. Provisional Patent Application Serial No. 60/225,206, filed Aug. 14, 2000 and U.S. patent application Ser. No. 09/929,226, filed Aug. 13, 2001, the disclosures of which are herein incorporated by reference. Retraction of the cutting tool from its operating position is described in more detail in U.S. Provisional Patent Application Serial No. 60/225,089, filed Aug. 14, 2000 and U.S. patent application Ser. No. 09/929,242, filed Aug. 13, 2001, the disclosures of which are herein incorporated by reference.

The configuration of reaction subsystem 24 typically will vary depending on which action(s) are taken. In the exemplary embodiment depicted in FIG. 1, reaction subsystem 24 is configured to stop the movement of cutting tool 14 and includes a brake mechanism 28, a biasing mechanism 30, a restraining mechanism 32, and a release mechanism 34. Brake mechanism 28 is adapted to engage operative structure 12 under the urging of biasing mechanism 30. During normal operation of miter saw 10, restraining mechanism 32 holds the brake mechanism out of engagement with the operative structure. However, upon receipt of an activation signal by reaction subsystem 24, the brake mechanism is released from the restraining mechanism by release mechanism 34, whereupon, the brake mechanism quickly engages at least a portion of the operative structure to bring the cutting tool to a stop.

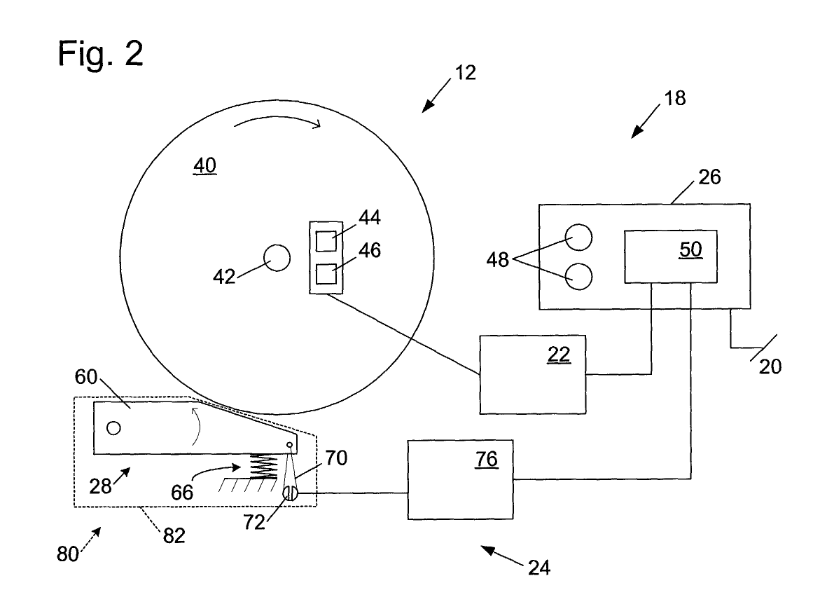

It will be appreciated by those of skill in the art that the exemplary embodiment depicted in FIG. 1 and described above may be implemented in a variety of ways depending on the type and configuration of operative structure 12. Turning attention to FIG. 2, one example of the many possible implementations of miter saw 10 includes a cutting tool 14 in the form of a circular blade 40 mounted on a rotating shaft or arbor 42. Blade 40 includes a plurality of cutting teeth (not shown) disposed around the outer edge of the blade. As described in more detail below, brake mechanism 28 is adapted to engage the teeth of blade 40 and stop rotation of the blade.

In the exemplary implementation, detection subsystem 22 is adapted to detect the dangerous condition of the user coming into contact with blade 40. The detection subsystem includes a sensor assembly, such as contact detection plates 44 and 46, capacitively coupled to blade 40 to detect any contact between the user's body and the blade. Typically, the blade, or some larger portion of cutting tool 14, is electrically isolated from the remainder of miter saw 10. Alternatively, detection subsystem 22 may include a different sensor assembly configured to detect contact in other ways, such as optically, resistively, etc. In any event, the detection subsystem is adapted to transmit a signal to control subsystem 26 when contact between the user and the blade is detected. Various exemplary embodiments and implementations of detection subsystem 22 are described in more detail in U.S. Provisional Patent Application Serial No. 60/225,200, filed Aug. 14, 2000, U.S. patent application Ser. No. 09/929,426, filed Aug. 13, 2001, U.S. Provisional Patent Application Serial No. 60/225,211, filed Aug. 14, 2000 and U.S. patent application Ser. No. 09/929,221, filed Aug. 13, 2001, the disclosures of which are herein incorporated by reference.

Control subsystem 26 includes one or more instruments 48 that are operable by a user to control the motion of blade 40. Instruments 48 may include start/stop switches, speed controls, direction controls, etc. Control subsystem 26 also includes a logic controller 50 connected to receive the user's inputs via instruments 48. Logic controller 50 is also connected to receive a contact detection signal from detection subsystem 22. Further, the logic controller may be configured to receive inputs from other sources (not shown) such as blade motion sensors, workpiece sensors, etc. In any event, the logic controller is configured to control operative structure 12 in response to the user's inputs through instruments 48. However, upon receipt of a contact detection signal from detection subsystem 22, the logic controller overrides the control inputs from the user and activates reaction subsystem 24 to stop the motion of the blade. Various exemplary embodiments and implementations of control subsystem 26 are described in more detail in U.S. Provisional Patent Application Serial No. 60/225,059, filed Aug. 14, 2000, U.S. patent application Ser. No. 09/929,237, filed Aug. 13, 2001, U.S. Provisional Patent Application Serial No. 60/225,094, filed Aug. 14, 2000 and U.S. patent application Ser. No. 09/929,234, filed Aug. 13, 2001, the disclosures of which are herein incorporated by reference.

In the exemplary implementation shown in FIG. 2, brake mechanism 28 includes a pawl 60 mounted adjacent the edge of blade 40 and selectively moveable to engage and grip the teeth of the blade. Pawl 60 may be constructed of any suitable material adapted to engage and stop the blade. As one example, the pawl may be constructed of a relatively high strength thermoplastic material such as polycarbonate, ultrahigh molecular weight polyethylene (UHMW), Acrylonitrile Butadiene Styrene (ABS), etc., or a metal such as aluminum, etc. It will be appreciated that the construction of pawl 60 will vary depending on the configuration of blade 40. In any event, the pawl is urged into the blade by a biasing mechanism such as a spring 66. In the illustrative embodiment shown in FIG. 2, pawl 60 is pivoted into the teeth of blade 40. It should be understood that sliding or rotary movement of pawl 60 may also be used. The spring is adapted to urge pawl 60 into the teeth of the blade with sufficient force to grip the blade and quickly bring it to a stop.

The pawl is held away from the edge of the blade by a restraining mechanism such as a fusible member 70. The fusible member is constructed of a suitable material adapted to restrain the pawl against the bias of spring 66, and also adapted to melt under a determined electrical current density. Examples of suitable materials for fusible member 70 include NiChrome wire, stainless steel wire, etc. The fusible member is connected between the pawl and a contact mount 72. Preferably fusible member 70 holds the pawl relatively close to the edge of the blade to reduce the distance pawl 60 must travel to engage blade 40. Positioning the pawl relatively close to the edge of the blade reduces the time required for the pawl to engage and stop the blade. Typically, the pawl is held approximately 1/32-inch to ¼-inch from the edge of the blade by fusible member 70; however other pawl-to-blade spacings may also be used within the scope of the invention.

Pawl 60 is released from its unactuated, or cocked, position to engage blade 40 by a release mechanism in the form of a firing subsystem 76. The firing subsystem is coupled to contact mount 72, and is configured to melt fusible member 70 by passing a surge of electrical current through the fusible member. Firing subsystem 76 is coupled to logic controller 50 and activated by a signal from the logic controller. When the logic controller receives a contact detection signal from detection subsystem 22, the logic controller sends an activation signal to firing subsystem 76, which melts fusible member 70, thereby releasing the pawl to stop the blade. Various exemplary embodiments and implementations of reaction subsystem 24 are described in more detail in U.S. Provisional Patent Application Serial No. 60/225,056, filed Aug. 14, 2000, U.S. patent application Ser. No. 09/929,240, filed Aug. 13, 2001, U.S. Provisional Patent Application Serial No. 60/225,170, filed Aug. 14, 2000, U.S. patent application Ser. No. 09/929,227, filed Aug. 13, 2001, U.S. Provisional Patent Application Serial No. 60/225,169, filed Aug. 14, 2000 and U.S. patent application Ser. No. 09/929,241, filed Aug. 13, 2001, the disclosures of which are herein incorporated by reference.

It will be appreciated that activation of the brake mechanism will typically require the replacement of one or more portions of safety system 18. For example, pawl 60 and fusible member 70 typically are single-use components which must be replaced before the safety system is ready to be used again. Thus, it may be desirable to incorporate one or more portions of safety system 18 in a cartridge that can be easily replaced. For example, in the exemplary implementation depicted in FIG. 2, safety system 18 includes a replaceable cartridge 80 having a housing 82. Pawl 60, spring 66, fusible member 70 and contact mount 72 are all mounted within housing 82. Alternatively, other portions of safety system 18 may be mounted within the housing. In any event, after the reaction system has been activated, the safety system can be reset by replacing cartridge 80. The portions of safety system 18 not mounted within the cartridge may be replaced separately or reused as appropriate. Various exemplary embodiments and implementations of a safety system using a replaceable cartridge are described in more detail in U.S. Provisional Patent Application Serial No. 60/225,201, filed Aug. 14, 2000, U.S. patent application Ser. No. 09/929,236, filed Aug. 13, 2001, U.S. Provisional Patent Application Serial No. 60/225,212, filed Aug. 14, 2000, and U.S. patent application Ser. No. 09/929,244, filed Aug. 13, 2001, the disclosures of which are herein incorporated by reference.

In the exemplary embodiment illustrated in FIG. 2, reaction subsystem 24 is configured to act on cutting tool 14 and stop the rotation of blade 40. As mentioned above, reaction subsystem 24 may be configured also to act on a different portion of operative structure 12 to stop and/or reverse the translation of blade 40 toward the workpiece and the user's body. Otherwise, the blade may continue to move toward the user's body even though the blade has stopped rotating. For example, U.S. Provisional Patent Application Serial No. 60/273,178, filed Mar. 2, 2001, U.S. Provisional Patent Application Serial No. 60/270,941, filed Feb. 22, 2001, and U.S. Provisional Patent Application Serial No. 60/270,942, filed Feb. 22, 2001, the disclosures of which are herein incorporated by reference, describe various alternative embodiments of reaction subsystem 24 configured to stop any downward movement of the miter saw blade and/or move the blade upward away from the workpiece and the user's body.

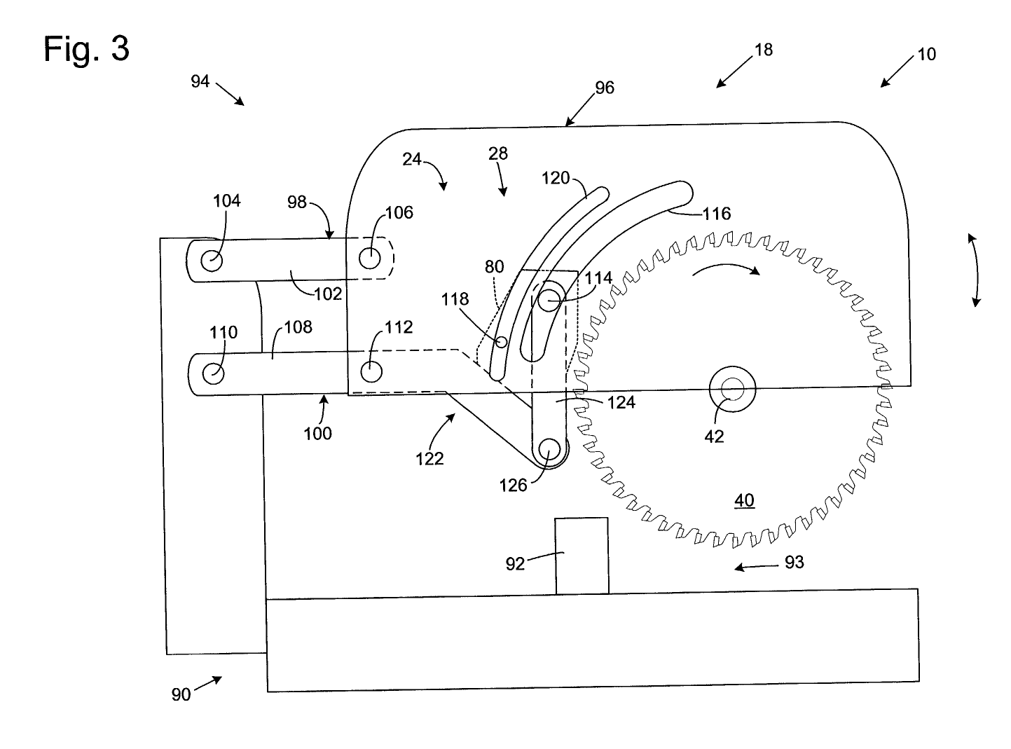

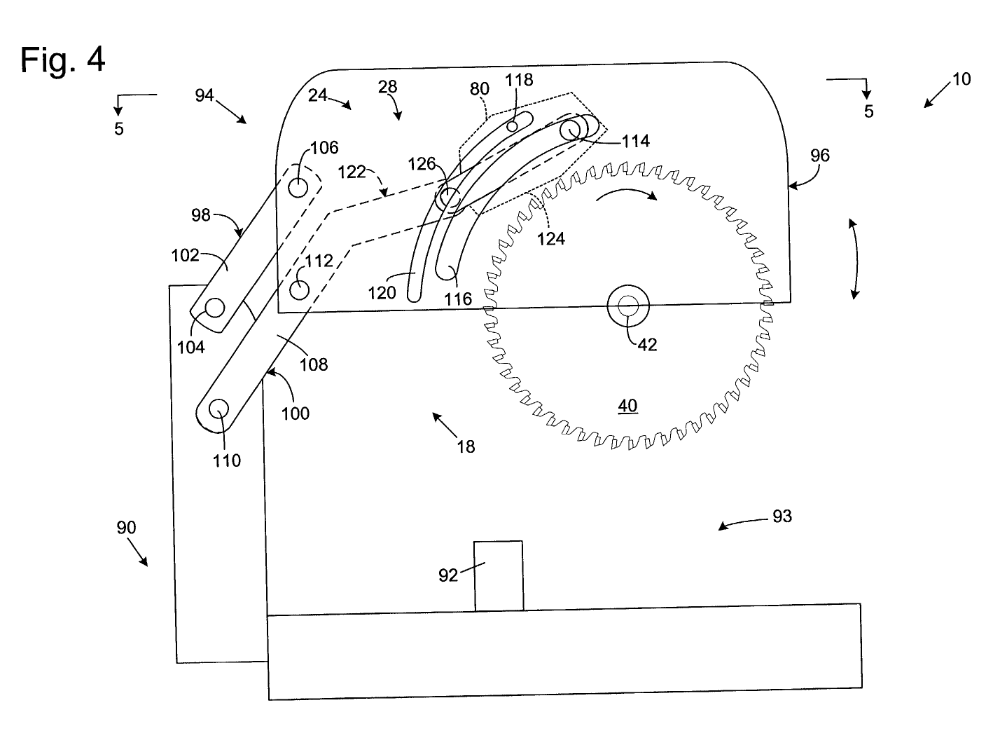

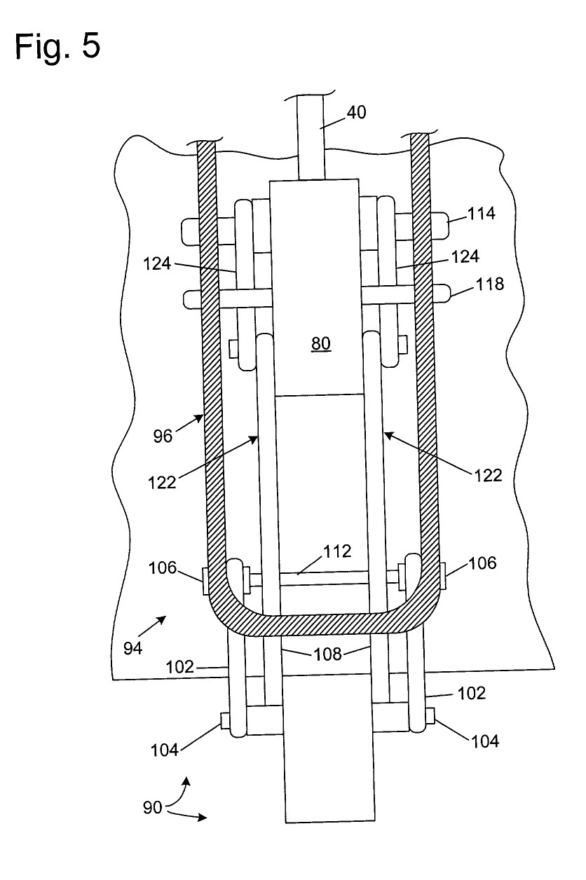

Turning attention now to FIGS. 3-6, another alternative embodiment is illustrated in which reaction subsystem 24 is configured to stop both the rotation and downward movement of blade 40. Exemplary miter saw 10 includes a base assembly 90 adapted to support a workpiece during cutting. Typically, one or more fences 92 are mounted on base assembly 90 and adapted to prevent workpieces from shifting across the base assembly during cutting. Base assembly 90 and fences 92 define a cutting zone 93 in which workpieces may be cut. The miter saw also includes a blade 40 mounted on an arbor 42. The arbor is driven by a motor assembly (not shown) which is supported above base assembly 90 by a pivot arm assembly 94. As shown in FIGS. 3 and 4, the pivot arm assembly is pivotal toward and away from cutting zone 93 to cut workpieces with the blade. In addition, some portion of the base assembly may be adjustable to tilt the blade relative to the workpiece to perform beveled cuts.

Pivot arm assembly 94 includes a housing 96 pivotally coupled to the base assembly by a first linkage assembly 98 and a second linkage assembly 100 vertically spaced-apart from the first linkage assembly. First linkage assembly 98 includes a pair of elongate arms 102 each connected at one end to one or more pivot pins 104 mounted in the base assembly, and at the opposite end to one or more pivot pins 106 mounted in housing 96. Similarly, second linkage assembly 100 includes a pair of elongate arms 108 each connected at one end to one or more pivot pins 110 mounted in the base assembly. A generally central portion of each arm 108 is connected to one or more pivot pins 112 mounted in housing 96. Arms 102 and 108 may be constructed of any suitable material adapted to support the weight of the housing, motor assembly, blade, etc., including metal, plastic, etc. Typically, pivot arm assembly 94 includes a spring or other biasing mechanism (not shown) adapted to maintain the housing in a fully upward position away from cutting zone 93 when the miter saw is not in use.

As shown in FIGS. 3 and 4, pivot pins 104 are vertically aligned with pivot pins 110, while pivot pins 106 are vertically aligned with pivot pins 112. Additionally, the vertical spacing between pivot pins 104 and 110 is substantially equal to the vertical spacing between pivot pins 106 and 112. As a result, housing 96 pivots toward and away from cutting zone 93 while maintaining a constant orientation in relation to the base assembly. In other words, the first and second linkage assemblies are configured to pivot housing 96 without causing the housing to rotate relative to the base assembly.

Reaction subsystem 24 includes a brake mechanism 28 having at least one brake pawl 60 housed in a replaceable cartridge 80. The cartridge and brake pawl are mounted on a movable pivot pin 114 configured to slide within a first set of channels 116 in either side of housing 96. First channels 116 define concentric arcs about arbor 42. As a result, pivot pin 114 is maintained at a constant radius from the arbor as it slides within first channels 116. A positioning pin 118 extends from one or both sides of cartridge 80 to slide within a second set of channels 120. The second set of channels also define concentric arcs about arbor 42 so that positioning pin 118 maintains a constant radius from the arbor as it slides within the second set of channels. Since the brake pawl is housed in cartridge 80, both the cartridge and brake pawl are maintained in a constant orientation relative to the arbor and the perimeter of the blade as pivot pin 114 slides within first channels 116. Additionally, the cartridge and brake pawl tilt with the housing when the miter saw is adjusted to make bevel cuts.

Cartridge 80 typically includes a restraining mechanism adapted to hold the brake pawl away from the blade against the urging of a biasing mechanism. In response to an activation signal, a release mechanism releases the brake pawl from the restraining mechanism to pivot into the blade, usually stopping the blade within approximately 2-5 milliseconds. Exemplary restraining mechanisms, biasing mechanisms, release mechanisms, cartridges and brake pawls are described in more detail above and in the incorporated references. In alternative embodiments, the cartridge may be omitted.

Housing 96 may include a removable section through which the cartridge may be installed or removed. Pivot pin 114 is typically removed by sliding it completely through the cartridge, thereby releasing the cartridge and brake pawl. Positioning pin 118 may also be slid completely through the cartridge. Alternatively, positioning pin 118 may be dual spring-loaded pins which can be depressed generally flush with the side of the cartridge to allow the cartridge to be installed and removed more easily. Optionally, housing 96 may include one or more removable covers adapted to cover one or both of the first and second set of channels during normal operation. It will be appreciated that cartridge 80 and housing 94 may be configured in any of a variety of different ways to allow the cartridge to be easily installed or removed.

Arms 108 include distal portions 122 spaced apart from pivot pins 110 and extending toward blade 40. As housing 96 is pivoted downward toward the workpiece, distal portions 122 pivot downward relative to the blade. Likewise, when housing 96 is pivoted upward away from the workpiece, distal portions 122 pivot upward relative to the blade. Pivot pin 114 is coupled to second linkage assembly 100 by a pair of links 124. The lower end of each link 124 is coupled to the distal portion of one of arms 108 by a pivot coupling 126, while the upper end of each link is pivotally coupled to pivot pin 114. Thus, pivot pin 114 is pushed or pulled along first set of channels 116 as distal portions 122 pivot relative to the blade. Links 124 may be constructed of any suitable material including metal, plastic, etc.

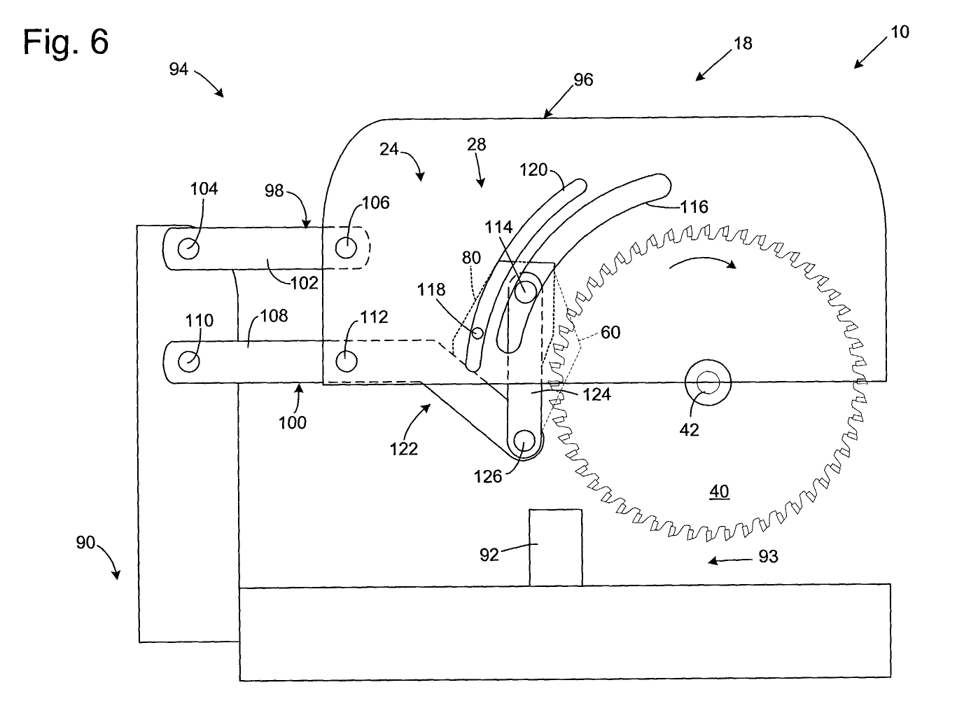

As can be seen by comparing FIGS. 3 and 4, the cartridge and brake pawl pivot or revolve about the center of blade 40 as second linkage assembly 100 pivots about pivot pin 110. The cartridge and brake pawl also can be seen as pivoting around the center of the blade as housing 96 pivots toward and away from the workpiece. Moreover, the cartridge and brake pawl are configured to pivot in a direction counter to the pivot direction of second linkage assembly 100 and housing 96. In other words, the cartridge and brake pawl pivot about the center of the blade in a counter-clockwise direction (as seen in FIG. 6) when the first linkage assembly and housing pivot about pivot pin 110 in a clockwise direction. Conversely, the cartridge and brake pawl pivot about the center of the blade in a clockwise direction (as seen in FIG. 6) when the first linkage assembly and housing pivot about pivot pin 110 in a counter-clockwise direction.

In response to an activation signal from a control subsystem (not shown), brake pawl 60 is pivoted into the teeth of blade 40, as shown in FIG. 6. When the brake pawl engages the blade the angular momentum of the blade produces a force on the brake pawl that tends to urge the brake pawl to move in a clockwise direction along first set of channels 116. In other words, at least a portion of the angular momentum of the blade is transferred to the brake pawl. The force on brake pawl 60 is transferred to first linkage assembly 100 by link 124. As a result, distal portions 122 are urged upward relative to the blade, thereby tending to pivot housing 96 in a counter-clockwise direction around pivot pin 110 and away from cutting zone 93.

The amount of upward force on distal portion 122 will depend on the ratio of the distance between couplings 112 and 126, and the distance between couplings 110 and 112. As the distance between couplings 112 and 126 is increased relative to the distance between couplings 110 and 112, the moment of any upward force at coupling 126 is increased. Typically, couplings 110, 112 and 126 are arranged so that the moment of the upward force on distal portion 122 is sufficient to stop any downward movement of the housing and blade under normal operating conditions (i.e., the housing is pivoted downward toward the cutting zone at a normal speed). Optionally, the couplings may be arranged so that the moment of the upward force on distal portion 122 is sufficient to overcome and reverse normal downward movement of the housing and blade, thereby retracting the blade upward away from cutting zone 93. In any event, brake pawl 60 is arranged to convert at least a portion of the kinetic energy of the rotating blade into an upward force on the housing and blade. Thus, exemplary brake mechanism 28 is configured to stop both the rotation of the blade and any downward movement of the blade using a single brake pawl. As a result, only a single cartridge need be replaced after the reaction subsystem has been triggered.

Since the upward force on the housing is produced by the rapid deceleration of the blade, the upward force on the housing is only temporary. Once the rotation of the blade has stopped, the housing is free to pivot toward or away from the cutting zone. Nevertheless, the blade will remain locked against further rotation until the cartridge is removed.

It will be appreciated that while one particular embodiment has been described above, many modifications and alterations are possible. As one example, brake pawl 60 and cartridge 80 may be coupled to distal portions of first linkage assembly 98 rather than second linkage assembly 100. As another example, second set of channels 120 may be eliminated and positioning pin 118 may be positioned on the cartridge to slide within the first set of channels 116. As a further example, the first and/or second set of channels may be formed in only a single side of housing 96, in which case pivot pin 114 and/or positioning pin 118 extend through only a single side of the housing. In view of the many modifications and alterations which are possible, it will be understood that the scope of the invention is not limited to the particular embodiments described herein but includes all such modifications and alterations.

As described above, the present invention provides a miter saw which is substantially safer than existing saws. The miter saw includes a safety system 18 adapted to detect the occurrence of a dangerous condition and stop movement of the blade and/or the pivot arm to prevent serious injury to a user. Alternatively, the safety system may be adapted for use on a variety of other saws in addition to miter saws. Several examples of such modifications and variations, as well as further detailed descriptions of miter saws and other saws, may be found in the following references, the disclosures of which are herein incorporated by reference: PCT patent application Serial No. PCT/US00/26812, filed Sep. 29, 2000; U.S. Provisional Patent Application Serial No. 60/233,459, filed Sep. 18, 2000; U.S. Provisional Patent Application Serial No. 60/225,210, filed Aug. 14, 2000; U.S. Provisional Patent Application Serial No. 60/225,058, filed Aug. 14, 2000; U.S. Provisional Patent Application Serial No. 60/225,057, filed Aug. 14, 2000; and U.S. Provisional Patent Application Serial No. 60/157,340, filed Oct. 1, 1999.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. A miter saw comprising:
a base assembly defining a cutting zone;
a first linkage assembly pivotally coupled to the base assembly;
a second linkage assembly pivotally coupled to the base assembly;
a housing having at least a first region pivotally coupled to the first linkage assembly and at least a second region pivotally coupled to the second linkage assembly, where the first and second linkage assemblies couple the housing to the base so that the housing may be moved toward and away from the cutting zone;
a motor mounted on the housing; and
a rotatable blade coupled to be driven by the motor to cut workpieces within the cutting zone when the housing is pivoted toward the cutting zone.

2. The miter saw of claim 1, where the first and second regions of the housing are arranged so that the second linkage assembly remains generally parallel to the first linkage assembly when the housing is moved toward and away from the cutting zone.

3. The miter saw of claim 1, where the first and second linkages are coupled to the housing and the base assembly so that the housing maintains a generally constant orientation relative to the base assembly as the housing is moved toward and away from the cutting zone.

4. The miter saw of claim 1, further comprising a detection system configured to detect one or more dangerous conditions between a person and the blade, and a reaction system configured to take one or more predetermined actions in the event a dangerous condition is detected by the detection system.

5. The miter saw of claim 4, where the one or more dangerous conditions includes accidental contact between a person and the blade.

6. The miter saw of claim 5, where the one or more predetermined actions includes stopping rotation of the blade.

7. The miter saw of claim 4, where the one or more predetermined actions includes stopping rotation of the blade.

8. The miter saw of claim 4, where the one or more predetermined actions includes stopping movement of the housing toward the cutting zone.

9. The miter saw of claim 4, where the one or more predetermined actions includes moving the housing in a direction away from the cutting zone.

10. The miter saw of claim 4, where the reaction system configured to take one or more predetermined actions includes at least one brake member configured to engage and stop rotation of the blade in the event a dangerous condition is detected by the detection system.

11. The miter saw of claim 10, where the blade has an angular momentum when rotated, and where the brake member is coupled to the first linkage assembly so that at least a portion of the angular momentum of the blade is transferred to the first linkage assembly when the brake member engages the blade.

12. The miter saw of claim 10, where the brake member is configured to revolve about the blade as the housing is moved toward and away from the cutting zone.

13. The miter saw of claim 12, where the housing includes one or more arcuate channels, and where the reaction system includes one or more pins disposed to slide within the one or more arcuate channels, and where the brake member is coupled to the one or more pins.

14. A miter saw comprising:
a base assembly defining a cutting zone;
a housing coupled to the base assembly to move toward and away from the cutting zone;
a rotatable blade mounted at least partially within the housing and configured to cut workpieces within the cutting zone when the housing is moved toward the cutting zone; and
a motor coupled to drive the blade;
a safety system including at least one brake member configured to selectively engage and stop the rotation of the blade upon the occurrence of one or more predetermined events, where the brake member is coupled to move in an arcuate path that is generally concentric with the blade as the housing is moved toward and away from the cutting zone.

15. The miter saw of claim 14, where the housing includes one or more arcuate channels, and where the brake member is coupled to move along the one or more arcuate channels.

16. The miter saw of claim 15, where the safety system includes at least one pin disposed to slide within the one or more arcuate channels, and where the brake member is mounted on the pin.

17. The miter saw of claim 14, further comprising at least one linkage assembly to couple the brake member to the housing.

18. The miter saw of claim 17, where the linkage assembly is configured to move the brake member in a generally clockwise direction about the blade when the housing is moved in a generally counter-clockwise direction about the base assembly.

19. The miter saw of claim 14, where the brake member is coupled to maintain a substantially constant orientation relative to the blade as the brake member moves in the arcuate path.

20. A miter saw comprising:
a base assembly defining a cutting zone;
a pivot arm assembly pivotally coupled to the base assembly and pivotal toward and away from the cutting zone;
a circular blade supported by the pivot arm assembly and configured to cut workpieces within the cutting zone when the pivot arm assembly is pivoted toward the cutting zone;
a motor configured to rotate the blade; and
a safety system configured to stop the rotation of the blade upon the occurrence of one or more dangerous conditions between a person and the blade, where the safety system includes at least one brake member configured to brake the blade;
where the safety system includes means for moving the brake member around the perimeter of the blade in the direction of the blade rotation when the pivot arm assembly is pivoted away from the cutting zone, and in the direction opposite the blade rotation when the pivot arm assembly is pivoted toward the cutting zone.
